(19) United States
(12) Patent Application Publication
(10) Pub. No.: US 2007/0127677 A1
(43) Pub. Date: Jun. 7, 2007

(54) Server apparatus

(75) Inventors: Koji Shima, Sagamihara-shi (JP); Shigeru Fukazawa, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/600,200

(22) Filed: Nov. 16, 2006

(30) Foreign Application Priority Data
Nov. 21, 2005 (JP) 2005-336205

(51) Int. Cl. H04M 3/42

(52) U.S. Cl. 379/211.02

(57) ABSTRACT

According to one embodiment, a server apparatus includes a memory which stores a call forward table in which a phone ID of a first phone terminal and a phone ID of a second phone terminal differing from the first phone terminal associated with each other, when the first phone terminal among the plurality of the phone terminals performs a transfer registration to transfer an incoming call to the second phone terminal, and a controller which updates the management table to correlate the user ID of the data terminal correlated with the phone ID of the first phone terminal with the phone ID of the second phone terminal based on the call forward table.

### CROSS-REFERENCE TO RELATED APPLICATIONS

This application is based upon and claims the benefit of priority from Japanese Patent Application No. 2005-336205, filed Nov. 21, 2005, the entire contents of which are incorporated herein by reference.

### BACKGROUND

1. Field

One embodiment of the invention relates to an improvement of a server apparatus in a visual communication system (VCS), in which, for instance, the server apparatus is connected to a telephone exchange apparatus via a communication path so as to enable treating a video signal and computer data in addition to a voice signal.

2. Description of the Related Art

In an office and a business institute, a private network system has been used. In the private network system, a telephone exchange apparatus such as a private branch exchange (PBX) or a key telephone apparatus houses, for instance, telephone sets as extension terminals, and the telephone exchange apparatus exchange-connects among the extension terminals and an external communication network such as a public network and among extension terminals with one another to enable making communications.

Recently, a system, connecting a server with data terminals such as video phone terminals and personal computers connected thereto to the telephone exchange apparatus via a transmission path and making a voice communication system using the telephone exchange apparatus cooperate with a data communication system using the server, has been proposed (for example, Jpn. Pat. Appln. KOKAI Publication No. 10-215322).

Meanwhile, in a system in a side-by-side type of the aforementioned telephone exchange apparatus and the server, a service so as to cooperate data communication connections among data terminals with calling states of the phone terminals to establish a video conference, etc., has been strongly desired. The foregoing system however requires a caller ID to display information related to the caller ID when a calling is made from the public network to any phone terminal. A VCS conducting an additional service such as a video conference has been still in a reviewing stage and has not been realized yet.

By the way, for realizing the above-mentioned VCS, the following measures are also needed to be examined.

For instance, in some cases, a phone terminal at a destination of an incoming call has already performed a transfer setting registration toward other telephone terminal. In these cases, when the incoming call cannot arrive at the destination thereof, in such cases in which the telephone terminal at the destination thereof has not logged in, has been busy, or has not made a response even if fixed time period has elapsed, it becomes possible to automatically transfer the incoming call to a phone terminal to be a destination of transfer. However, in the forgoing VCS, a means, for achieving automatic cooperation between the phone terminal with the incoming call transferred thereto and the data terminal correlated with the phone terminal at the call forward (CF) origin, has not developed yet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view illustrating a visual communication system (VCS) regarding a first embodiment of the present invention;

FIG. 2 is an exemplary block diagram illustrating a functional configuration of a VCS server shown in FIG. 1;

FIG. 3 is an exemplary view illustrating one example of storage contents of a connection information management table shown in FIG. 2;

FIG. 4 is an exemplary view illustrating one example of storage contents of an extension terminal-data terminal (VC) correlating table shown in FIG. 2;

FIG. 5 is an exemplary view illustrating one example of storage contents of a session information management table shown in FIG. 2;

FIG. 6 is an exemplary view illustrating one example of storage contents of a call forward (CF) registration table shown in FIG. 2;

FIG. 7 is an exemplary view illustrating one example of storage contents of an update permission table shown in FIG. 2;

FIG. 8 is an exemplary view illustrating one example of storage contents of a release permission table shown in FIG. 2;

FIG. 9 is an exemplary schematic sequence view illustrating transmitting/receiving operations of information among extension terminals, a main apparatus, the VCS server and data terminals when CF setting is performed in the first embodiment of the present invention;

FIG. 10 is an exemplary flowchart illustrating control procedures of the VCS server when performing the CF setting in the first embodiment of the present invention;

FIG. 11 is an exemplary schematic sequence view illustrating transmitting/receiving operations of information among extension terminals, a main apparatus, a VCS server and data terminals when CF setting is released in a second embodiment of the present invention;

FIG. 12 is an exemplary flowchart illustrating control procedures of the VCS server when the CF setting is released in the second embodiment of the present invention; and

FIG. 13 is an exemplary view illustrating one example of storage contents of a CF registration table in a third embodiment of the present invention.

### DETAILED DESCRIPTION

Various embodiments according to the invention will be described hereinafter with reference to the accompanying drawings. In general, according to one embodiment of the invention, a server apparatus which receives a call information event including phone IDs specifying a plurality of phone terminals to which call connections are performed and cooperates communication connections at a plurality of data terminals with the call connections based on a management table with user IDs stored therein, the user IDs assigned to the plurality of the data terminals, respectively, by associating with the phone IDs of the plurality of the phone terminals, comprising: a memory which stores a call forward table in which a phone ID of a first phone terminal and a phone ID of a second phone terminal differing from the first phone terminal associated with each other, when the first phone terminal among the plurality of the phone terminals performs a transfer registration to transfer an incoming call to the second phone terminal; and a controller which updates the management table to correlate the user ID of the data terminal correlated with the phone ID of the first phone terminal with the phone ID of the second phone terminal based on the call forward table.

### First Embodiment

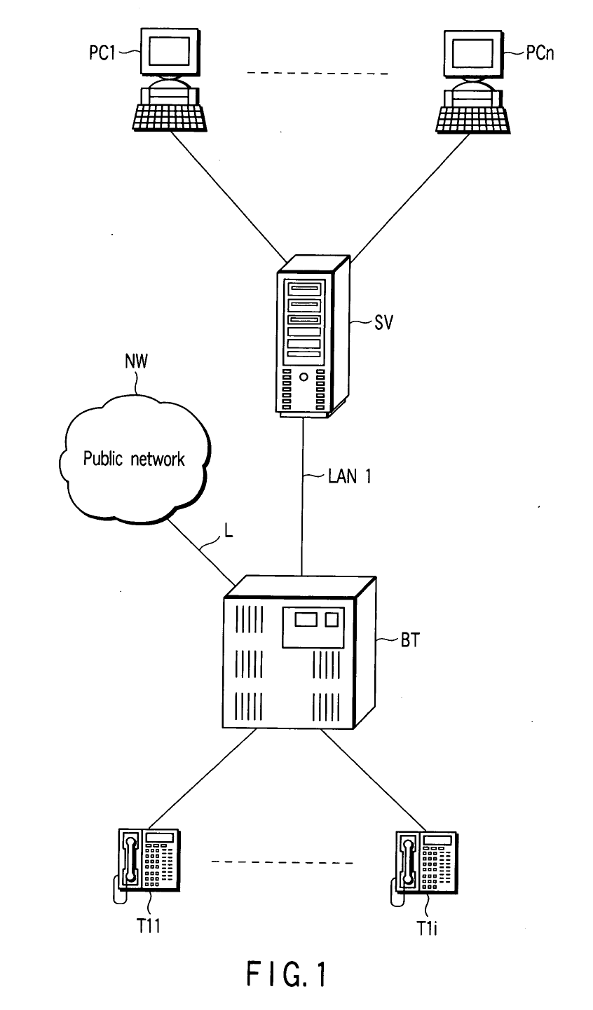

FIG. 1 is a schematic configuration view showing a visual communication system (VCS) regarding a first embodiment of the present invention.

The system, as shown in FIG. 1, has a main apparatus BT and a VCS server SV and connects between the main apparatus BT and the VCS server SV via a local area network (LAN) 1.

The main apparatus BT houses extension terminals T11-T1i via inner wirings. The main apparatus BT is connected to a public network NW via an office line L. The main apparatus BT executes an exchange processing among the extension terminals T11-T1i with one another, or among the extension terminals T11-T1i and the public network NW.

The VCS server SV houses a plurality of data terminals PC1-PCn via an Internet protocol (IP) network. Every data terminal PC1-PCn consists of a general-purpose personal computer and operates in associating with each extension terminal T11-T1i, respectively.

The forgoing VCS server SV executes an additional function to the main apparatus BT to process, for example, media information on a video, etc.

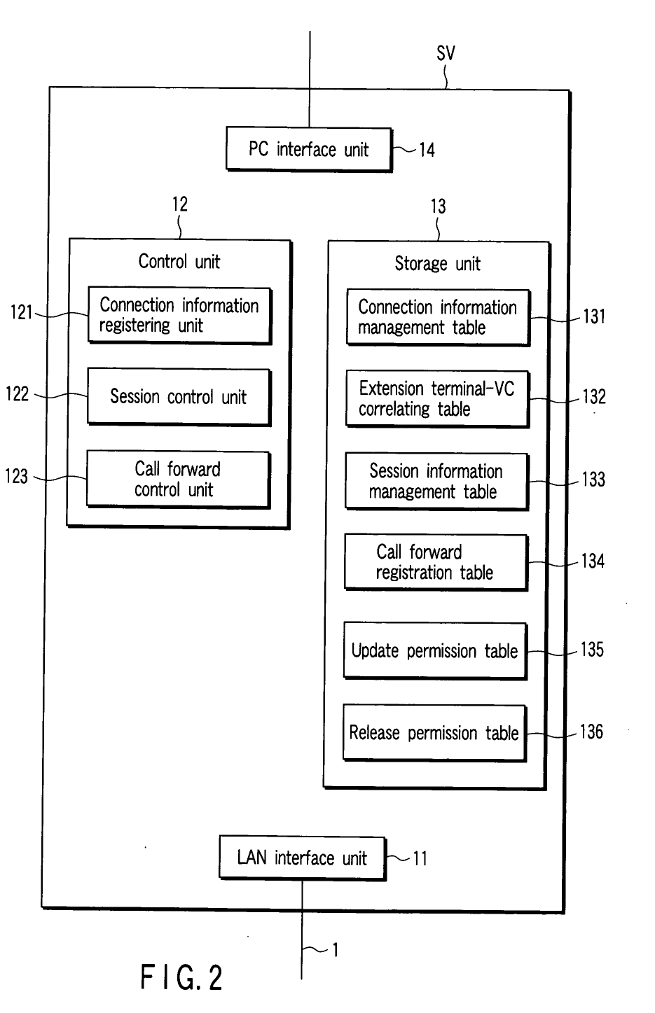

FIG. 2 is a block diagram showing a functional configuration of the VCS server SV.

The VCS server SV includes a LAN interface unit 11, a control unit 12, a storage unit 13 and a PC interface unit 14. Out of them, the LAN interface unit 11 performs an interface process to and from a LAN 1.

The PC interface unit 14 conducts interface processes to and from the data terminals PC1-PCn.

The storage unit 13 stores routing information, etc., necessary for connection control by the control unit 12. Further, the storage unit 13 includes a connection information management table 131 (hereinafter, referred to a s management table 131), an extension terminal-VC correlating table 132 (hereinafter, referred to as table 132), a session information management table 133 (hereinafter, referred to as management table 133), a call forward (CF) registration table 134 (hereinafter, referred to as registration table 134), an update permission table 135, and a release permission table 136.

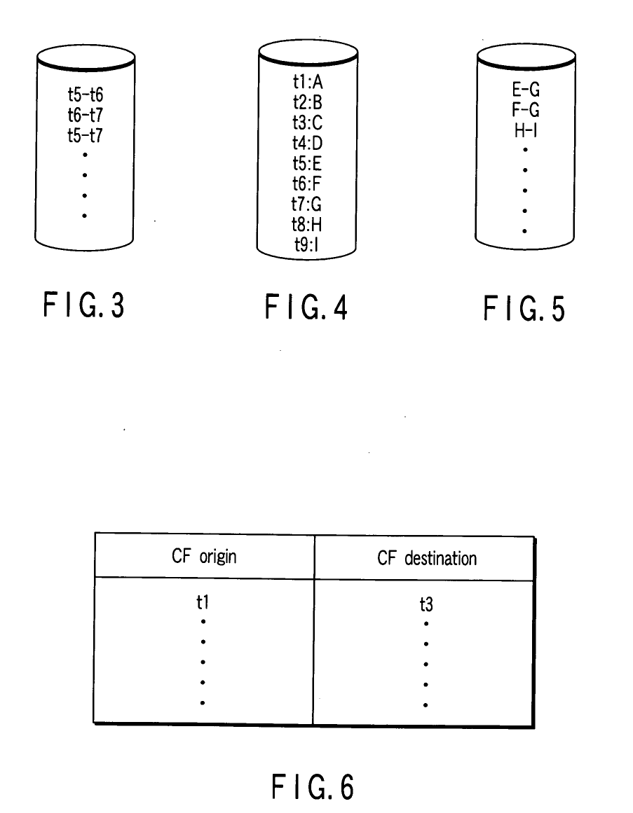

The management table 131 stores, as shown in FIG. 3, data indicating correspondence relationships among each phone number (phone ID) of the extension terminals T11-T1i and state information showing connection states. Symbols t1-t9 indicate each phone number ID of the extension terminals T11-T19, respectively. Here, for purpose of simplification, the extension terminals T11-T1i are represented by the extension terminals T11-T19.

As shown in FIG. 4, the table 132 stores the data indicating the correspondence relationships among the extension terminals T11-T1i and the data terminals (VCs) PC1-PCn. Symbols A-I in FIG. 4 indicate each user ID of the data terminals PC1-PC9, respectively.

The management table 133 stores information showing session states among the data terminals PC1-PC9, as shown in FIG. 5.

The registration table 134, as shown in FIG. 6, stores data showing correspondence relationships among each phone ID of the extension terminals T11-T1i to be CF origins, respectively, and each phone ID of the extension terminals T11-T1i to be CF destinations, respectively.

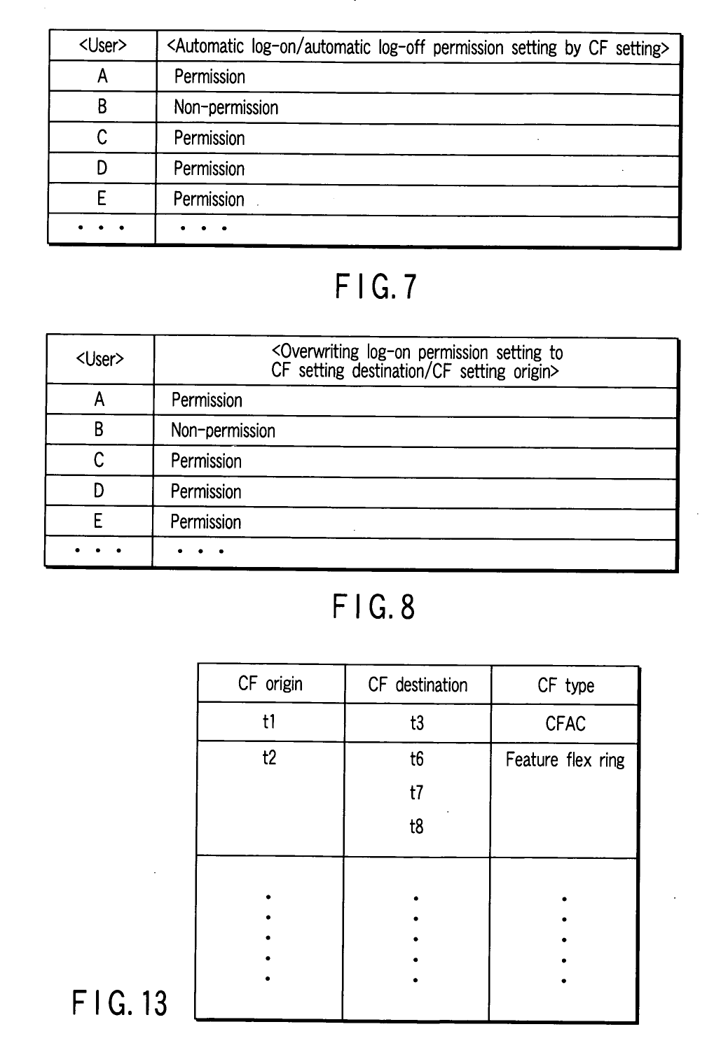

The update permission table 135, as shown in FIG. 7, stores data indicating correspondence relationships among each user ID of the data terminals PC1-PC9 and update permission information showing permission/non-permission of automatic log-on/automatic log-off by CF setting.

The release permission table 136, as shown in FIG. 8, stores data showing correspondence relationships among each user ID of the data terminals OC1-PC9 to the CF origins and release permission information showing permission/non-permission of overwriting log-on to CF setting destinations/CF setting origins in the case in which each user ID of the data terminals PC1-PC9 correlated with the CF destinations, respectively, is present. The update permission table 135 and the release permission table 136 are set by means of a maintenance terminal (not shown) and the like connected to the VCS server SV.

On the other hand, the control unit 12 includes a connection information registration unit 121 (hereinafter, referred to as registration unit 121), a session control unit 122, and a CF control unit 123 (hereinafter, referred to as control unit 123) as new functions regarding the present invention in addition to a control function regarding a state management of the data terminals PC1-PCn and the cooperation operations among the data terminals PC1-PCn and the extension terminals T11-T1i.

With the call information event which has been notified from the main apparatus BT analyzed, the registration unit 121, for instance, determines the fact of becoming communications between the extension terminal T15 and the extension terminal T16 to add state information “t5-t6” into the management table 131.

The session control unit 122 reads out that the extension terminal T15 is correlated with a data terminal PC 5(E) and the extension terminal T16 is correlated with a data terminal PC 6(F) from the table 132 based on the updated state information to retrieve session states of the data terminals PC5 and PC6 from the management table 133. For instance, when communications start from now, since the data terminals PC5 and PC6 have not started sessions yet, the session control unit 122 controls so that the data terminals PC5 and PC6 start the sessions. After establishing the sessions of data terminals PC5 and PC6, the session control unit 122 updates the storage contents in the management table 133.

When the extension terminal T11 performs CF setting to transfer the incoming call to the extension terminal T13, the control unit 123 updates the storage contents in the table 132 so as to associate the user ID (A) of the data terminal PC1 correlated with the phone ID (t1) of the extension terminal T11 with the phone ID (t3) of the extension terminal T13. At this moment, the control unit 123 refers to respective storage contents in the update permission table 135 and the release permission table 136, and for instance, if automatic log-on resulted from CF setting and overwriting log-on to a CF setting destination for the user ID (A) are permitted, it updates the storage contents in the table 132.

Next, operations of the VCS configured as given above will be described.

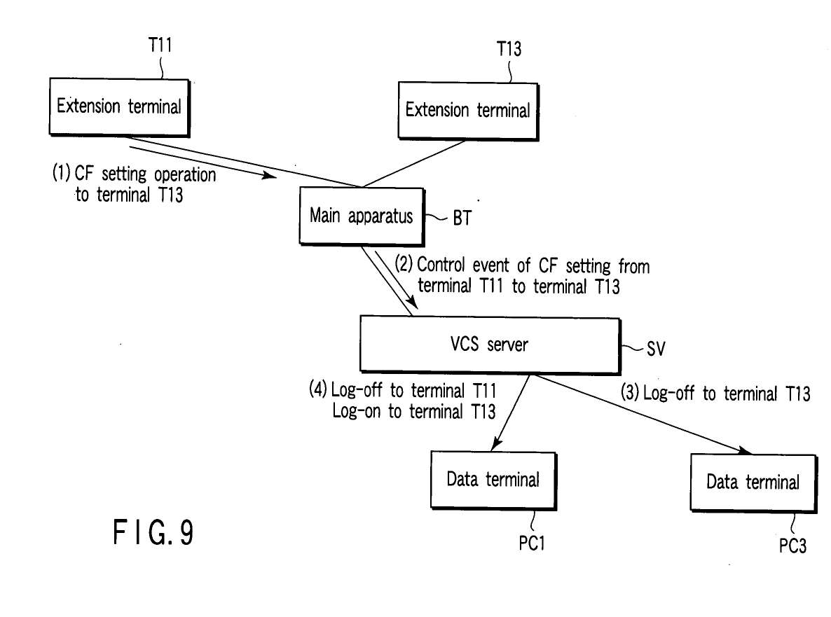

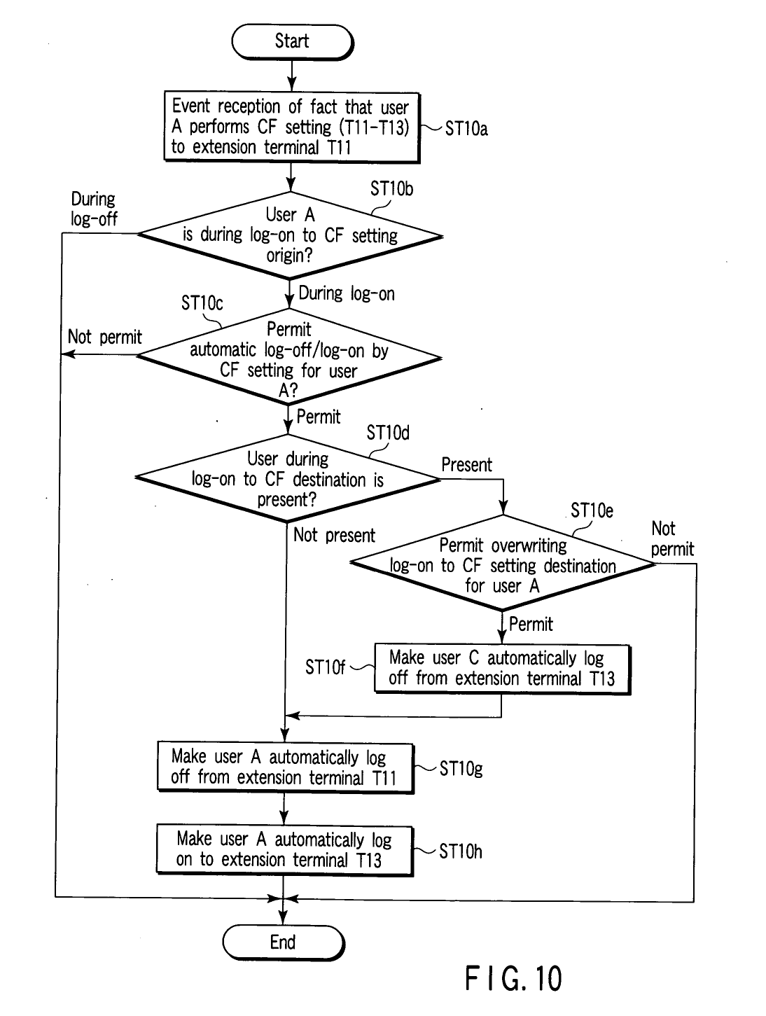

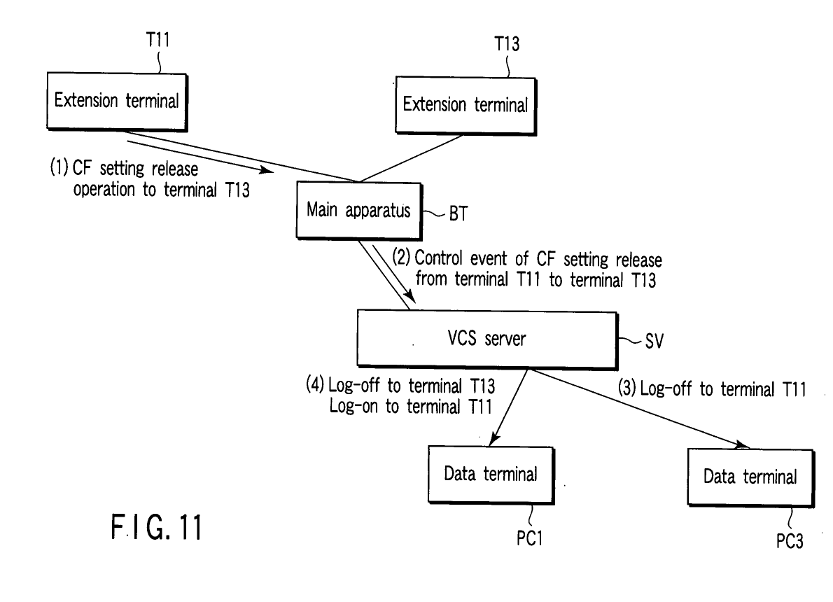

FIG. 9 is a sequence view showing operations in conducting log-on and log-off of each data terminal PC1 and PC3 when the CF setting from the extension terminal T11 to the extension terminal T13 is performed. FIG. 10 is a flowchart showing control processing procedures of the VCS server SV at that time.

For example, it is presumed that a user conducts a CF setting operation from the extension terminal T11 to the extension terminal T13 (FIG. 9 (1)). The extension terminal T11 then transmits its request signal to the main apparatus BT. When receiving the request signal, the main apparatus BT sets the extension terminal T13 as a CF destination, and transmits a control event indicating the fact of the CF setting from the extension terminal T11 to the extension terminal T13 to the VCS server SV (FIG. 9(2)).

When receiving the control event (block ST10a), the VCS server SV firstly sets the phone ID (t1) of the extension terminal T11 included in the control event as the CF destination and the phone ID (t3) of the extension terminal T13 as the CF destination to register them in the registration table 134. Referring to the table 132, the VCS server SV determines whether or not the data terminal PC1 to be correlated with the phone ID (t1) is during log-on (block ST10b). If it is during logged-off, the VCS server SV terminates the processing as it is.

On the contrary, if it is during log-on, the VCS server SV refers to the update permission table 135 to determine whether or not the automatic log-off/log-on based on the CF setting for the user ID (A) of the data terminal PC1 is permitted (block ST10c).

Here, it being permitted, the VCS server SV refers to the table 132 to determine whether or not a user who is during log-on to the phone ID (t3) of the extension terminal T13 is present (block ST10d).

Here, since a user ID (C) of a data terminal PC3 which has logged in to the phone ID (t3) of the extension terminal T13 is present, the VCS server SV refers to the release permission table 136 to determine whether overwriting log-on to the CF setting destination for the user ID (C) of the data terminal PC3 is permitted or not (block ST10e).

Here, it being permitted, the VCS server SV sifts from the block ST10e to a block ST10f to automatically log off the data terminal PC3 from the extension terminal T13, namely, delete “t3:C” in the table 132 (FIG. 9(3)). Next to this, the VCS server SV automatically logs off the terminal PC1 from the extension terminal T11, namely, deletes “t1:A” in the table 132 (block ST10g) to automatically log on to the extension terminal T13, so that, add “t3:A” into the table 132 (block ST10h).

Thus, when an incoming call destined to the extension terminal T11 arrives, the user of the extension terminal T11 may communicate with an opposite calling party through the extension T13 and also becomes possible to automatically start a video communication with the opposite calling party by using the data terminal PC1.

If the overwriting is not permitted in the block 10c and the block ST10w, the VCS server SV terminates the processing as it is. In the block ST10d, if the user who is during log-on to the CF destination is not present, the VCS server SV sifts to the process in the block S10g.

As described above, in the first embodiment of the present invention, in performing the CF setting, the VCS server SV stores the registration table 134, in which the phone ID (t1) of the extension terminal T11 to be the CF origin is associated with the phone ID (t3) of the extension terminal T13 to be the CF destination, in the storage 13 to manage it. Further, the VCS server SV refers to the registration table 134 to updates the table 132 so that the user ID (A) of the data terminal PC1 correlated with the phone ID of the extension terminal ST11 to associate with the phone ID (t3) of the extension terminal T13.

Accordingly, even when the incoming call destined to the extension terminal T11 arrives, the extension terminal T13 may be associated with the data terminal PC1 correlated with the extension terminal T11 without having to interpose manual operations, so that the convenience of the user is dramatically improved.

In the first embodiment of the present invention, with having set the update permission information on the automatic update of the table 132 for each user in the update permission table 135 in the VCS server SV, the VCS server SV may perform optimum updating of the table 132 for each user by updating the table 132 so that a certain data terminal PC1 automatically correlates with the extension terminal T13 in transfer-registering from the extension terminal T11 to the extension terminal T13. In contrast, the VCS may perform the optimum updating of the table 132 by updating the table 132 so that another data terminal PC2 correlates with the extension terminal T13 only when the user itself determines the necessity in the registering of the transfer.

Furthermore, in the first embodiment of the present invention, with having set the release permission information whether or not the release of the correlation between the CF destination and the data terminals PC1-PCn associated with their CF destinations for each user in the release permission table 136 of the VCS server SV is automatically performed or not, the VCS server SV may perform optimum updating of the table 132 for each user by updating the table 132 so that a certain data terminal PC1 automatically releases the correlation between the extension terminal T13 and the data terminal PC3 in transfer registering from the extension terminal T11 to the extension terminal T13. In contrast, the VCS server SV may perform the optimum updating of the table 132 by updating the table 132 so that another data terminal PC2 releases the correlation between the extension terminal T13 and the data terminal PC3 only when the user itself determines the necessity in the registering of the transfer.

### Second Embodiment

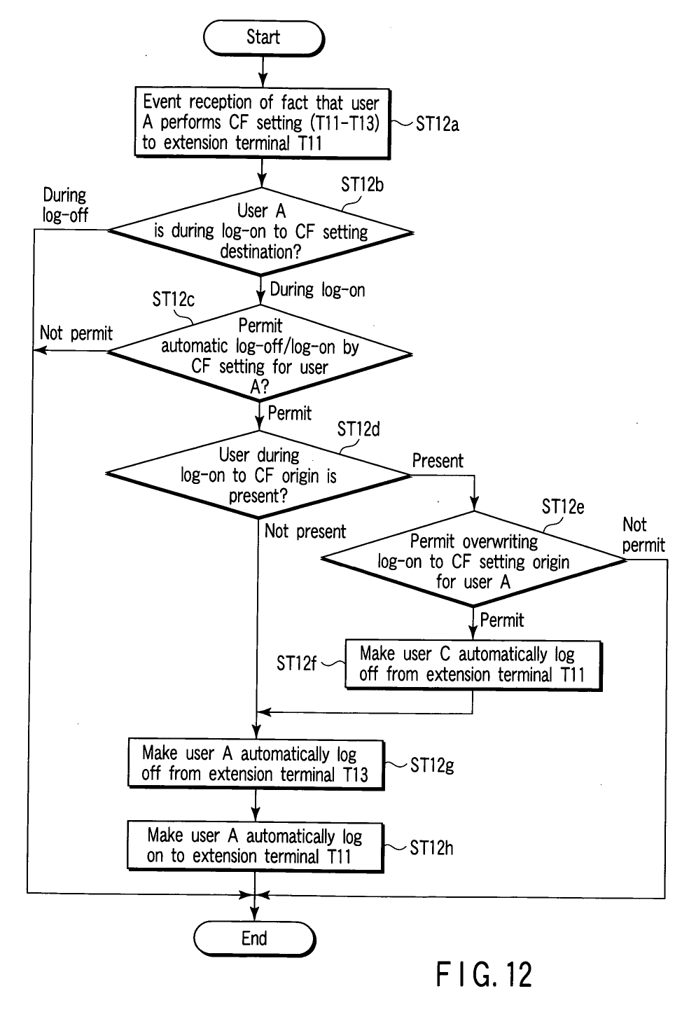

FIG. 11 is a sequence view showing operations in conducting of log-on and log-off of each data terminals PC1 and PC3 when the CF setting from the extension terminal T11 to the extension terminal T13 is released. In FIG. 11, the same components as those of FIG. 9 are designated by the identical symbols and explained. FIG. 12 is a flowchart showing control processing procedures of the VCS server SV in the operations shown in FIG. 11.

In the extension terminal T11, for instance, it is supposed that the user conducts a CF setting release operation from the extension terminal T11 to the extension terminal T13 (FIG. 11(1)). The extension terminal T11 then transmits the request signal for the release operation to the main apparatus BT. When receiving the request signal, the main apparatus BT releases the CF destination for the extension terminal T13 and transmits the control event, which indicates the fact of releasing the CF setting from the extension terminal T11 to the extension terminal T13, to the VCS server SV (FIG. 11(2)).

When receiving the control event (block ST12a), the VCS server SV firstly deletes the phone ID (t1) of the extension terminal T11 and the phone ID (t3) of the extension terminal T13 included in the control event from the registration table 134 to determine whether or not the data terminal PC1 to be correlated with the phone ID (t3) is during log-on by referring to the table 132 (block ST12b). Here, if the data terminal PC1 has logged in, the VCS server SV terminates the processing as it is.

On the contrary, otherwise stated, the VCS server SV refers to the update permission table 135 to determine whether or not the automatic log-off/log-on resulting from the CF setting for the user ID (A) of the data terminal PC1 is permitted (block ST12c).

Here, being permitted, the VCS server SV refers to the table 132 to determine whether any user who is during log-on to the phone ID (t3) of the extension terminal T11 is present or not (block ST12d).

In this case, since the user ID (C) of the data terminal PC3 which is during log-on to the phone ID (t1) of the extension terminal T11 is present, the VCS server SV refers to the release permission table 136 to determine whether or not the overwriting log-on to the CF setting origin in relation to the user ID (C) of the data terminal PC3 is permitted (block ST12d).

Here, being permitted, the VCS server SV shifts from the block ST12e to the block ST12f to automatically log off the data terminal PC3 from the extension terminal T11, that is, delete “t1:C” in the table 132 (FIG. 11(3)). The VCS server SV then automatically logs off the data terminal PC1 from the extension terminal T13, namely, deletes “t3:A” in the table 132 (block ST12g) to automatically log on to the extension terminal T11, that is, adds “t1:A” into the table 132 (block ST12h).

Thus, the user of the extension terminal T11 may communicates with the opposite calling party through the extension terminal T11 and also becomes possible to automatically start video communications with the opposite calling party by using the data terminal PC1.

If the permissions are not made in the blocks ST12c and ST12e, the VCS server SV terminates the processing as it is. In the block ST12d, if any user who is during log-on to the CF origin is not present in the block ST12d, the VCS server SV shifts to the processing in the block ST12g.

As mentioned above, in the second embodiment of the present invention, in releasing the CF setting, the VCS server SV deletes the phone IDs (t1 and t3) of the corresponding extension terminals T11 and T13 in the registration table 134, and also it updates the table 132 so that the user ID (A) of the data terminal PC1 related to the phone ID (t3) of the extension terminal T13 to be the CF destination is associated with the phone ID (t1) of the extension terminal T11 to be the CF origin.

Accordingly, after releasing the CF setting, even when an incoming call destined to the extension terminal T11 arrives, the system may cooperate the extension terminal T11 and the data terminal PC1 correlated with the extension terminal T13 without having to interpose any manual operation, thereby, the convenience of the user is extremely improved.

### Third Embodiment

FIG. 13 is a view showing one example of storage contents in the registration table 134 regarding the second embodiment of the present invention.

The registration table 134 stores data on the correspondence relationships among each phone ID of the extension terminals T11-T1i to be the CF origins, each phone ID of the extension terminals T11-T1i to be the CF destinations, and information of CF types indicating CF kinds.

For example, in the extension terminal T12, it is assumed that the user performs CF setting operations from the extension terminal T12 to the extension terminals T16, T17 and T18. The extension terminal then transmits its request signal to the main apparatus BT. When receiving the request signal, the main apparatus BT sets the extension terminals T16, T17 and T18 as the CF destinations and transmits the fact of the CF setting from the extension terminal T12 to the extension terminals T16, T17 and T18 and the control event indicating the CF types, such as “feature flex ring” which conducts incoming call control in turn at every fixed time period to the VCS server SV.

When receiving the control event, the VCS server SV firstly sets the phone ID (t2) of the extension terminal T12 included in the control event as the CF origin and sets the phone IDs (t6, t7 and t8) of the extension terminals T16, T17 and T18 as the CF destinations, respectively, and registers them in the registration table 134 and also registers them in association with the CF type information.

After this, when the data terminals PC6, PC7 and PC8 correlated with the extension terminals T16, T17 and T18, respectively, are present, the VCS server SV logs off these data terminals PC6, PC7 and PC8.

As given above, in the third embodiment of the present invention, the registration table 134 having stored the CF origins, the CF destinations and also the CF type information by associating with one another, the VCS server SV may optimally correlate the extension terminals T11-T1i with the data terminals PC1-PCn in response to the CF type information.

### Other Embodiment

The present invention is not limited to the aforementioned embodiments. For instance, although the first and second embodiments have been described on condition that “Call Forward types” are “All Call” (all calls should be arrived at CF destinations unconditionally), it is also possible to finely control in response to “Call Forward Busy”, “Call Forward No Answer”, and “Call Forward Busy No Answer”.

Although the foregoing second embodiment stores the storage contents shared with the update permission table and the release permission table shown in the foregoing first embodiment, they may store storage contents differing from each other.

Having described examples which provides the main apparatuses and the VCS servers individually in the given each embodiment, the VCS servers may incorporate the functions of the main apparatuses.

Furthermore, the configuration and kind of the VCS server, the kind of the telephone exchange apparatus (not limited to main apparatus but PBX is also usable), the kind of the extension terminal, the kind of the data terminal, the storage contents of each table, the method for correlating with the data terminal in the CF setting, or the like may be implemented with a variety of deformations without departing from the point of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives a call information event including phone IDs specifying a plurality of phone terminals to which call connections are performed and cooperates communication connections at a plurality of data terminals with the call connections based on a management table with user IDs stored therein, the user IDs assigned to the plurality of the data terminals, respectively, by associating with the phone IDs of the plurality of the phone terminals, comprising:
a memory which stores a call forward table in which a phone ID of a first phone terminal and a phone ID of a second phone terminal differing from the first phone terminal associated with each other, when the first phone terminal among the plurality of the phone terminals performs a transfer registration to transfer an incoming call to the second phone terminal; and
a controller which updates the management table to correlate the user ID of the data terminal correlated with the phone ID of the first phone terminal with the phone ID of the second phone terminal based on the call forward table.

2. The server apparatus according to claim 1, further comprising:
an update permission memory which stores update permission information showing permission/non-permission of an automatic update of the management table by the transfer registration by associating with the user ID, wherein
the controller executes an update of the management table based on the update permission information.

3. The server apparatus according to claim 1, further comprising:
a release permission memory which stores release permission information showing permission/non-permission of a release of association between the second phone terminal and the second data terminal by associating with the user ID of the first data terminal correlated with the first phone terminal, when the user ID of the second data terminal correlated with the phone ID of the second phone terminal is present, wherein
the controller executes an update of the management table based on the release permission information.

4. The server apparatus according to claim 1, wherein
the memory stores a call forward table in which the phone ID of the first phone terminal, the phone ID of the second phone terminal, and transfer type information indicating a type of call forward are associated with one another; and
the controller executes an update of the management table based on the transfer type information in the call forward table.

5. The server apparatus according to claim 1, wherein the controller updates the management table to delete the phone IDs of the first and the second phone terminals in the call forward table and to associate the user ID of the data terminal correlated with the phone ID of the second phone terminal with the phone ID of the first phone terminal, when the transfer registration by the first phone terminal to the second phone terminal is released.

6. The server apparatus according to claim 5, further comprising:
an update permission memory which stores update permission information showing permission/non-permission of an automatic update of the management table by the transfer registration release by associating with the user ID, wherein
the controller executes an update of the management table based on the update permission information.

7. The server apparatus according to claim 5, further comprising:
a release permission memory which stores release permission information showing permission/non-permission of a release of association between the first phone terminal and the second data terminal by associating with the user ID of the first data terminal correlated with the second phone terminal when the user ID of the second data terminal correlated with the phone ID of the first phone terminal is present, wherein
the controller executes an update of the management table based on the release permission information.
